(19) United States
(12) Patent Application Publication
(10) Pub. No.: US 2016/0098298 A1
(43) Pub. Date: Apr. 7, 2016

(54) METHODS AND APPARATUS FOR INTEGRATED WORK MANAGEMENT

(71) Applicant: Pegasystems Inc., Cambridge, MA (US)

(72) Inventors: Alan Trefler, Brookline, MA (US); Mark Replogle, Groton, MA (US)

(21) Appl. No.: 14/597,207

(22) Filed: Jan. 14, 2015

Related U.S. Application Data
(63) Continuation of application No. 12/386,959, filed on Apr. 24, 2009, now abandoned.

(51) Int. Cl. G06F 9/50; G06F 9/48

(52) U.S. Cl. CPC G06F 9/5011; G06F 9/4881

(57) ABSTRACT

Described herein are techniques for integrated work management. An integrated work management server processes one or more datum of one or more source systems. The datum relates to at least one work item representing at least one assignment to be processed by a resource. An integrator is coupled to the integrated work management server. The integrator uses the one or more datum to create, store and/or update a combined work queue for the resource. The combined work queue comprises any of at least one work item and at least one assignment. One or more prioritization rules specify one or more criteria. The integrator prioritizes the combined work queue by evaluating the criteria in accord with the one or more datum.

### BACKGROUND

1. Technical Field

This application relates to digital data processing and, more particularly, to automated methods and apparatus for managing/monitoring work and enterprise content in multiple systems.

2. Description of Related Art

Computer systems, and software applications executing thereon, may be used to perform a variety of different tasks including automation of work processing such as, for example, in connection with work items in a business process. One drawback of some software applications used to automate work processing is that such applications are only “self-aware”—that is, they cannot manage work across multiple systems or provide a unified view of the work/enterprise content across an organization that deploys multiple software applications/systems with different types of technologies and versions. Users of such systems must separately attend to every individual system deployed within the organization (e.g. Payroll, Human Resources, Time Sheets, etc.) in order to determine, prioritize and process their complete list of outstanding tasks. This approach can prove to be very time-consuming, especially if there are many separate systems used by an organization to create and/or manage different types of work (referred to below collectively as “source systems”) and if such systems are not accessible in the same geographic location. The mere fact that users must check every system regardless of whether that system has any current tasks/assignment for that user hinders work automation and process efficiency.

### SUMMARY OF THE INVENTION

In accordance with one aspect of the invention is an integrated work management system, comprising: an integrated work management server for processing one or more datum of one or more source systems interfaced with the integrated work management server, wherein the datum of each of the one or more source systems relates to at least one work item and the work item represents at least one assignment to be processed by at least one resource; an integrator coupled to the integrated work management server, wherein the integrator uses the one or more datum to create, store and/or update a combined work queue for the resource, the combined work queue comprising any of at least one work item and at least one assignment; and one or more prioritization rules specifying one or more criteria, wherein the integrator prioritizes the combined work queue by evaluating the criteria in accord with the one or more datum. The one or more datum may be any of: periodically propagated to the integrated work management server from the one or more source systems; and periodically retrieved by the integrated work management server, wherein the integrated work management server queries the one or more source systems and the one or more source systems return the one or more datum in response. Each of the one or more source systems may be any of a single server and a cluster. Each of the one or more source systems may support one or more software applications. The one or more datum of each of the one or more source systems may further include any of a context of at least one authorized resource with access to the source system; one or more workbaskets wherein each of the one or more workbaskets comprises any of at least one work item and at least one assignment that is eligible for processing by more than one authorized resource; any of an age, work type and an urgency level associated with any of at least one assignment and at least one work item; and, system information that can be used to identify any of the source system and the one or more software applications. The context may include information related to any of security and identification data, roles, privileges, skills, age, locale and disability settings of the authorized resource. The context may be used to identify any of at least one assignment and at least one work item that is eligible for any of creation, review and processing by the authorized resource. The system may further comprise a gateway coupled to the integrated work management server, wherein after the authorized resource specifies any of at least one assignment and at least one work item for any of creation, review and processing, the gateway identifies at least one source system corresponding to any of the specified assignment and the specified work item. The integrator may set an expiration period for any of the specified assignment and the specified work item and may remove any of the specified assignment and the specified work item from the combined work queue for the duration of the expiration period. Any of the specified assignment and the specified work item may be processed in the corresponding source system according to pre-defined processing steps and any the specified assignment and the specified work item may be permanently removed from the combined work queue after said processing. The pre-defined processing steps may be any of defined and stored in the corresponding source system. The integrated work management server may be interfaced with the one or more source systems through a network, and the gateway may identify at least one corresponding source system by constructing a Uniform Resource Locator for the corresponding source system. The authorized resource may be any of an operator, an inbound service, a batch process, a software application and a digital data processing system comprising one or more digital data processors. The authorized resource may use a user interface in communication with the integrated work management server to specify any of at least one assignment and at least one work item for any of creation, review and processing, wherein the user interface presents a view of any of the combined work queue and at least one source system to the authorized resource. The user interface may allow the authorized resource to choose one source system among a plurality of source systems that are identified by the gateway to correspond to any of the specified assignment and the specified work item. The user interface may permit the authorized resource to query the source system to review any of at least one assignment and at least one work item in the source system. The user interface may permit the authorized resource to create any of at least one new assignment and at least one new work item in the source system. The user interface may allow the authorized resource to retrieve any of a highest priority work item and a highest priority assignment from any of the combined work queue and the one or more workbaskets by querying the one or more datum. The user interface may allow the authorized resource to any of: view a list of the one or more source systems interfaced with the integrated work management server; disconnect the interface between the one or more source systems and the integrated work management server; filter the combined work queue to exclude any of work items and assignments of the one or more source systems from the combined work queue; and filter the combined work queue to exclude any of the work items and assignments of the one or more workbaskets. The user interface may allow the authorized resource to customize the prioritization rules. The integrator and the gateway may be included in the integrated work management server. The urgency level may indicate a relative urgency with respect to any of at least one other assignment and at least one other work item within the source system. Any of the specified assignment and the specified work item may be permanently removed when the integrated work management server receives an updated one or more datum from the corresponding source system after said processing, said updated datum excluding any of the specified assignment and the specified work item. The integrated work management server may be a first integrated work management server that processes the one or more datum of said one or more source systems and the system may further comprise one or more other integrated work management servers interfaced with at least a portion of said one or more source systems to perform processing of the datum of every source system included in said portion. One or more identification datum of a resource may be transmitted to the gateway when the resource attempts to establish a connection with the integrated work management server. The resource may be authenticated by the gateway before establishing the connection by comparing the one or more identification datum of the resource with the context of one or more authorized resources.

In accordance with another aspect of the invention is a computer-implemented method for providing integrated work management comprising: processing, using an integrated work management server, one or more datum of one or more source systems interfaced with the integrated work management server, wherein the datum of each of said one or more source systems relates to at least one work item and the work item represents at least one assignment to be processed by at least one resource; providing an integrator coupled to the integrated work management server, wherein said integrator uses the one or more datum to create, store and/or update a combined work queue for the resource, said combined work queue comprising at least one work item and at least one assignment; and prioritizing the combined work queue by evaluating one or more criteria specified by one or more prioritization rules, wherein the one or more criteria is evaluated by the integrator in accord with said one or more datum. The one or more datum may be any of: periodically propagated to the integrated work management server from the one or more source systems; and periodically retrieved by the integrated work management server, wherein the integrated work management server queries the one or more source systems and the one or more source systems return the one or more datum in response. Each of the one or more source systems may be any of a single server and a cluster. Each of the one or more source systems may support one or more software applications. The one or more datum of each of the one or more source systems may further include any of a context of at least one authorized resource with access to the source system; one or more workbaskets wherein each of the one or more workbaskets comprises any of at least one work item and at least one assignment that is eligible for processing by more than one authorized resource; any of an age, work type and an urgency level associated with any of at least one assignment and at least one work item; and system information that can be used to identify any of the one or more source systems and the one or more software applications. The context may include information related to any of security and identification data, roles, privileges, skills, age, locale and disability settings of the authorized resource. The context may be used to identify any of at least one assignment and at least one work item that is eligible for any of creation, review and processing by the authorized resource. The method may further comprise the step of providing a gateway coupled to the integrated work management server, wherein after the authorized resource specifies any of at least one assignment and at least one work item for any of creation, review and processing, the gateway identifies at least one source system corresponding to any of the specified assignment and the specified work item. The method may also include setting an expiration period for any of the specified assignment and the specified work item and removing any of the specified assignment and the specified work item from the combined work queue for the duration of the expiration period. The method may also include processing any of the specified assignment and the specified work item in the corresponding source system according to pre-defined processing steps and permanently removing any of the specified assignment and the specified work item from the combined work queue after said processing. The pre-defined processing steps may be any of defined and stored in the corresponding source system. The method may include interfacing the integrated work management server with the one or more source systems through a network, and identifying at least one corresponding source system by constructing a Uniform Resource Locator for the corresponding source system. The authorized resource may be any of an operator, an inbound service, a batch process, a software application and a digital data processing system comprising one or more digital data processors. The authorized resource may use a user interface in communication with the integrated work management server to specify any of at least one assignment and at least one work item for any of creation, review and processing, wherein the user interface presents a view of any of the combined work queue and at least one source system to the authorized resource. The user interface may allow the authorized resource to choose one source system among a plurality of source systems that are identified by the gateway to correspond to any of the specified assignment and the specified work item. The user interface may permit the authorized resource to query the source system to review any of at least one assignment and at least one work item in the source system. The user interface may permit the authorized resource to create any of at least one new assignment and at least one new work item in the source system. The user interface may allow the authorized resource to retrieve any of a highest priority work item and a highest priority assignment from any of the combined work queue and the one or more workbaskets by querying the one or more datum. The user interface may allow the authorized resource to perform any of: viewing a list of the one or more source systems interfaced with the integrated work management server; disconnecting the interface between the one or more source systems and the integrated work management server; and filtering the combined work queue to exclude any of work items and assignments of the one or more source systems from the combined work queue. The user interface may allow the authorized resource to customize the prioritization rules. The integrator and the gateway may be included in the integrated work management server. The urgency level may indicate a relative urgency with respect to any of at least one other assignment and at least one other work item within the source system. The method may include permanently removing any of the specified assignment and the specified work item upon the integrated work management server receiving an updated one or more datum from the corresponding source system after said processing, said updated datum excluding the specified assignment. The integrated work management server may be a first integrated work management server that processes the one or more datum of said one or more source systems, wherein the system may further comprise one or more other integrated work management servers interfacing with at least a portion of said one or more source systems to perform processing of the datum of every source system included in said portion. The method may also include transmitting one or more identification datum of a resource to the gateway when the resource attempts to establish a connection with the integrated work management server and authenticating the resource before establishing the connection by comparing the one or more identification datum of the resource with the context of one or more authorized resources.

In accordance with another aspect of the invention is a computer-implemented method for providing integrated work management comprising: processing one or more datum of one or more source systems interfaced with an integrated work management server, wherein the datum of each of said one or more source systems relates to at least one work item and the work item represents at least one assignment to be processed by at least one resource; using the one or more datum to create, store and/or update a combined work queue for the resource comprising any of at least one work item and at least one assignment; and providing one or more prioritization rules specifying one or more criteria, wherein the combined work queue is prioritized by evaluating said criteria in accordance with said one or more datum.

In accordance with another aspect of the invention is a computer readable medium comprising executable code thereon for providing integrated work management, the computer readable medium comprising executable code for: processing one or more datum of one or more source systems interfaced with an integrated work management server, wherein the datum of each of said one or more source systems relates to at least one work item and the work item represents at least one assignment to be processed by at least one resource; using the one or more datum to create, store and/or update a combined work queue for the resource comprising any of at least one work item and at least one assignment; and providing one or more prioritization rules specifying one or more criteria, wherein the combined work queue is prioritized by evaluating said criteria in accordance with said one or more datum.

### BRIEF DESCRIPTION OF THE DRAWINGS

Features and advantages of the present invention will become more apparent from the following detailed description of exemplary embodiments thereof taken in conjunction with the accompanying drawings in which:

FIG. 1 is an example illustration of an embodiment of systems and networks (s) that may utilize the techniques described herein;

FIGS. 2A and B are a flowchart depicting, according to one embodiment of the techniques herein, the interaction between the digital data processors shown in FIG. 1; and

FIG. 3 shows, according to one embodiment of the techniques herein, a sample user interface screen for presenting a consolidated view of a digital data processing system of the type shown in FIG. 1.

### DETAILED DESCRIPTION OF EMBODIMENT(S):

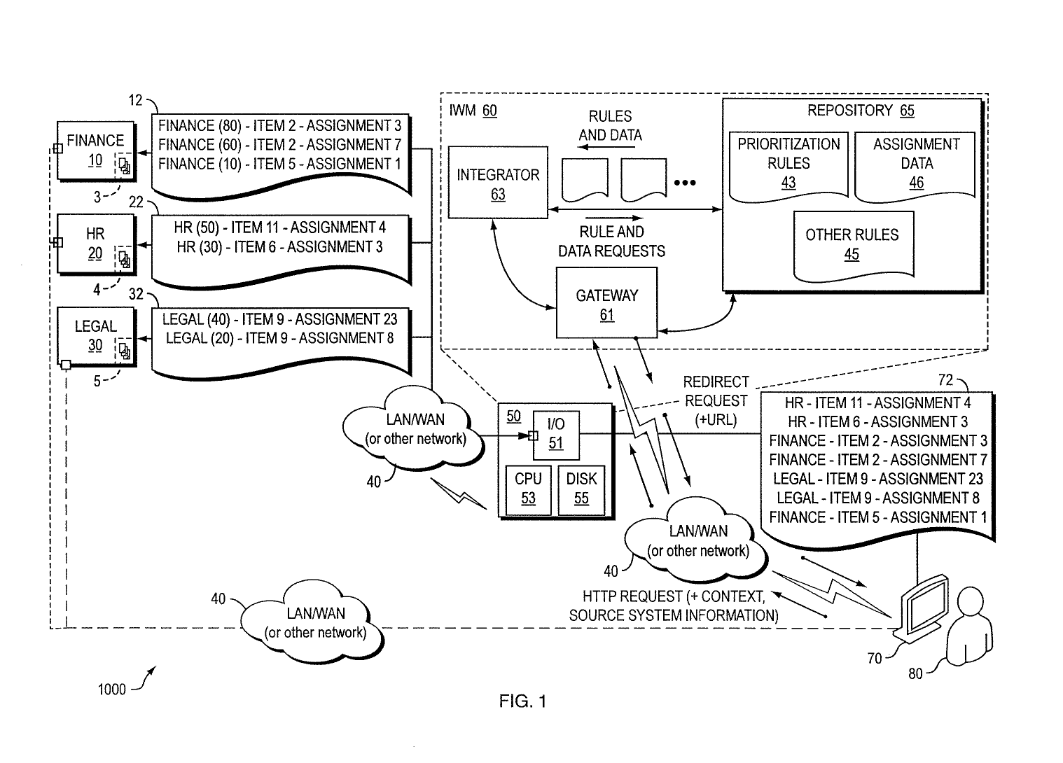

Referring to FIG. 1, shown is an example illustration of an embodiment of systems and networks (s) that may utilize the techniques described herein. The example 1000 illustrates a system 60 and environment for automated methods and apparatus for management and integration of work and enterprise content across multiple source systems 10, 20 and 30. The system 60 may also be referred to as an integrated work management server or system (hereinafter “IWM”) executing on an exemplary server digital data processor 50, which may be a personal computer, workstation, mainframe, or other digital data processing apparatus of the type known in the art capable of executing applications, programs and/or processes. The server processor 50, as well as others described herein, may include hardware and/or software such as a CPU 53, one or more data storage devices such as disks 55, devices for I/O 51, and the like. The IWM is coupled to a client digital data processor 70 via the Internet, a wide area network (WAN), metropolitan area network (MAN), local area network (LAN), telephone networks and/or a combination of these and other networks (wired, wireless, public, private or otherwise)—all indicated here by the element 40.

In the illustrated embodiment, client digital data processor 70 is depicted as an individual workstation. However, in other embodiments it may be any personal computer, mainframe, personal digital assistants (PDAs), mobile phone, embedded processor and/or other digital data apparatus of the type known in the art, one or more of which can be adapted for operation in accord with the teachings hereof. In the example 1000 of FIG. 1, it should be noted that the client digital data processor 70 is of the type and configuration used in a corporate or enterprise environment, e.g., with a server 50 that is coupled to multiple source systems 10, 20 and 30, an individual workstation 70 being used by an operator 80 via network(s) 40. However, the techniques herein may be practiced in any variety of other computing environments, networked or otherwise.

Illustrated source systems 10, 20 and 30 are server digital data processors that execute in the networked environment and may comprise personal computers, workstations, mainframes, or other digital data processing apparatus. Each illustrated source system may be a single server digital data processor or a cluster of servers working together in environments, networked or otherwise. In a typical embodiment, illustrated here, a client data processor 70 coupled to each source system via a network 40 may be used in development mode, e.g., by software engineers, test engineers, systems administrators, etc. (collectively, “developers”) to develop, test and maintain/or software applications. Likewise, client data processor 70 may be employed by an end-user operator 80 to execute instantiations of one or more applications on each source system.

In the discussion that follows, source systems 10, 20 and 30 assume the role of development and execution devices, i.e., they are treated as if used by developers to develop, test and maintain applications, as well as the role of executing such applications at the behest of client device 70 used by an operator 80. Moreover, the operator 80 may be a developer of the applications or an end user operator of the applications. Still further, it is also assumed for sake of simplicity of discussion that applications execute on a single server digital data processor; however, in practice, the applications may execute on or over multiple server digital data processors (e.g., in client-server mode, peer-to-peer mode, etc.).

In the example 1000, source systems 10, 20 and 30 are shown executing exemplary Finance, Human Resources and Legal software applications. It will be appreciated that such software applications may comprise various different types of software applications written, tested and revised by developers and executed by users. By way of non-limiting example, such applications may be any multi-user enterprise software applications such as, for example, business process management applications that may be used in a variety of different industries and lines of business. By way of non-limiting example, such industries and lines of business may include, health care, finance, life sciences, telecommunications, government, insurance, business process outsourcing, automotive, retail product sales, clothing, marketing, computer services and food and restaurant industry. Moreover, each application may comprise one or more components, rules, modules, systems, and so forth (collectively, “components”), as is common in the art. In operation, these components allow applications to automate work processing because they typically define the sequence and other details of processing steps that are applied by each application to individual units of work (hereinafter “work items”). Although, in the illustrated embodiment, these processing steps are created, stored and executed on the source systems, in other embodiments, these may be created, stored, and/or executed otherwise.

The automated work items typically contain information related to the type of work being processed by the application(s), as well as data related to a plurality of assignments/tasks that need to be acted upon by one or more resources (e.g., a person, another system or a piece of equipment) during processing. A resource may be a person, software application, inbound service or batch processing software, digital data processing system comprising one or more digital data processors, and the like, which may complete an assignment or otherwise perform processing upon a work item. Thus, for example, in a source system comprising a server digital data processor executing a software application that is used to automate automobile insurance quotes, each work item may represent an auto insurance quote request that contains work data about the applicant, vehicle, driver details, as well as the coverage selected for the quote. Furthermore, the work item may also contain information about the resource assigned to act upon the work item at a particular processing step, the type of task(s) to be completed at that step by the assigned resource, the timeline for completing the task/assignment etc. (hereinafter “assignment data”). In some embodiments, the assignment data may change during work item processing as tasks and resources are updated at different stages of the process.

The illustrated source system 30 executes one or more software applications that are used to automate the processing of legal work within an enterprise. One such application may be a contract request software application where each work item represents a request from a sales representative to the legal department to generate a contract for a prospective customer or vendor. When the request is initiated, a work item may be instantiated containing work data about the requestor, prospective customer or vendor, as well as the requested business and legal terms to be included in the contract. In the next processing step after request initiation, the work item may need to be routed to an appropriate resource to complete the task/assignment (hereinafter “assignment”) of generating the contract based upon the work data contained within the work item. The assignment data (e.g. assignment description, assignment status, goal deadline, due deadline, urgency level, resource skills, capabilities desired and/or required to complete the assignment etc.) associated with that particular assignment may also be stored in the work item. The source system 30 and/or application, in turn, may apply a variety of techniques that use the assignment data to perform prioritization, routing and/or other work management of the work item and its associated assignments. By way of non-limiting example, techniques described in U.S. Patent Publication No. 2006/0173724, U.S. patent application Ser. No. 11/046,211, filed Jan. 28, 2005, “Methods and Apparatus for Work Management and Routing”, Trefler et al., (the '211 application), which is incorporated by reference herein, may be employed by the source system and/or application to optimally route work items and/or individual assignments to one or more resources using the assignment data. In the '211 application, techniques are described for service-level based and/or skills-based assignment of work to one or more resources based on fitness, for example, of skills required by the former to those provided by the latter. Techniques described in the '211 application may be incorporated for use in an embodiment in accordance with techniques described herein. For example, an embodiment in accordance with the techniques herein may assign a work item and/or assignment to one or more resources for processing based on a matching or similarity between a set of skills and/or level of skill or other characteristics attributable to a resource (e.g., that can be provided by the resource) and a set of required and/or desired characteristics associated with the work item and/or assignment which may characterize those which are necessary and/or desired in order to provide services in connection with the work item and/or assignment. As a further example, a resource may be an employee performing a service on behalf of a company where work items created relate to providing services to consumers or customers of the company. A work item may be assigned to a particular employee or group of employees for processing based on the type and level of skills of each employee selected in accordance with those which are deemed desired and/or required to complete the work item processing.

In a manner similar to that as described herein for source system 30, other source systems such as systems 10 and 20 may execute one or more software applications to automate the processing of other work in different areas within an enterprise (e.g., here, Finance and Human Resources, respectively).

It will be appreciated that there may be multiple assignments associated with one work item that can be performed by one or more resources (i.e. “open or pending assignments”) at any point in time (e.g., see, queue 12, first two assignments 3 and 7 for the same work item, “item 2”). In the contract request example stated above, the work item processing steps may be defined in parallel such that while the contract generation assignment is waiting in queue to be processed by an appropriate resource (e.g., a lawyer in the legal department) another assignment associated with the same work item may be simultaneously open for a sales supervisor resource to review/approve the business terms requested by the sales representative who initiated the request. Furthermore, the data structure definitions for work items in some source systems may be such that there is a “cover work item” that includes a plurality of linked “child work items” each comprising work data and assignment data of its own. Still other variations in data structure and work processing definitions are possible in different embodiments of the techniques herein.

In the illustrated embodiment of FIG. 1, software applications perform steps during the course of work item processing to generate assignments, which are in turn routed to one or more resources based upon logic defined in the software application. For example, during execution of a workflow in an application, a router function at a processing step can choose the most appropriate resource(s) to receive a newly created assignment based upon logic that is pre-defined and implemented in the router function. Such assignments that are awaiting processing may be associated with either a specified resource (and appear on the work list for that resource) or with a workbasket that represents a shared pool of open assignments/work items from which several different resources can select items on which to work.

In operation, a single application executing on a source system may have multiple workbaskets to categorize its work items. For example, a benefits enrollment HR application executing on the source system 20 may have the following workbaskets:
NewEnrollmentRequests (e.g., new health care or other enrollment requests);
FinanceApprovals (e.g., approval(s) needed for financial requests);
OverdueRequests (e.g., requests of one or more different types of work for which processing may have been required and/or desired by a particular date, within a particular time period from when a request was created, and the like, and such processing has not been completed by such date, or within the specified time period, and the like); and
BenefitProviderFollowUp (e.g., a followup activity or processing to be completed related to a health care provider)

The number of workbaskets that may be used in connection with a software application may vary depending upon on several factors, such as, the structure of the organization deploying the application, the types of assignments made, the number and types of access roles (i.e., class access rights), types of processing to be performed, reporting requirements, and the like. For example, one organization may need to have assignments routed to work lists for one line of business and to workbaskets for another line of business. Another approach might be to consider the number of unique instructions associated with assignments—and to create that number of workbaskets. For example, if an application has one assignment instructing the users to collect available rates, another to verify employment, and a third to crosscheck references, then it may make sense to have three workbaskets, one for each of the foregoing. In this case, a pool of workers can draw assignments from a designated workbasket to handle common tasks. Still other variations in workbasket and work list configuration are possible in other embodiments.

In some embodiments using the techniques herein, work lists and workbaskets function in tandem for more efficient teaming and workload balancing. Qualified resources can pull cases from workbaskets to their work lists, transfer cases to other resources, or return cases to workbaskets. Furthermore, an application may automatically route assignments in a workbasket to users based on work schedules, due dates, skills, workloads, and other factors. Still further, managers may transfer assignments from a workbasket to operator work lists.

In the example 1000 of FIG. 1, elements 12, 22 and 32 represent individual work queues, respectively, from source systems 10, 20 and 30, for operator 80. Each work queue, ordered in decreasing urgency, comprises data related to outstanding or pending assignments (from both work lists and eligible workbaskets that the operator can access) that have been created during work processing in each source system and are yet to be completed.

As used here, an ‘urgency’ value is a numeric value used for indicating priority of work to be performed, both for automated tasks (e.g., by agents, batch processing or other automated system-to-system use) and any assignments requiring user interactions. The urgency of an assignment for a particular work item may be represented as an integer value between 0 and 100 that defines the importance (i.e., priority) of promptly completing and resolving a particular assignment. In the illustrated embodiment of FIG. 1 with reference to elements 12, 22 and 32, the urgency with respect to work items and associated assignments within a single source system is enclosed between parentheses (e.g., Finance (80)—Item2—Assignment 3, where the urgency is denoted as an integer value of 80 for work item 2 and assignment 3), and the higher the integer value, the greater the urgency. In one embodiment, each source system may rank its own assignments in terms of relative priority with respect to other assignments within the same source system. This urgency value may be initially computed and later updated by an application based upon one or more of a variety of factors (e.g., service levels, dollar amounts, customer status, backlogs etc.) and stored as a data element within a work item data structure. Furthermore, urgency values may be used to prioritize work to be performed (work items/assignments) within a single system for a particular operator as illustrated in FIG. 1. For example, the prioritization rules 3, 4 and 5 specified for all software applications executing on each of source systems 10, 20 and 30 in FIG. 1 are such that all assignments with the highest urgency appear on top of each work queue, elements 12, 22 and 32 of each source system, respectively, for operator 80. Since urgency values may change from the time an assignment is created (e.g., to reflect adjustments from operator input or manager input), the order of the work queue may also be updated automatically to reflect such change in urgency values. Such adjustments to urgency within a source system or an application can bring visibility and attention to the most important work that is in process.

It will be appreciated that even though in the illustrated embodiment, the work queues are ordered based upon urgency values for individual assignments, in other embodiments, work may be prioritized by urgency values for work items. Such work item urgency values may depend upon the urgency values of the one or more assignments associated with the work item or they may be computed independently of the status of the associated assignment(s). Still other variations in methods of associating work items and assignments and prioritization of work are possible in other embodiments using the techniques described herein.

Furthermore, as will be described in more detail below, prioritization criteria evaluated by the IWM system 60 (e.g. one or more criterion specified by prioritization rules 43) can use the urgency value, alone or in combination with other data elements, to specify the order that assignments appear on a resource's integrated or combined work queue across multiple source systems (e.g., containing work items/assignments from multiple different source systems). In other words, an embodiment in accordance with techniques herein may define criteria used by the IWM system 60 to re-prioritize work queues of individual source system(s) and compile an ordered composite list of work item/assignments for a resource across multiple source systems.

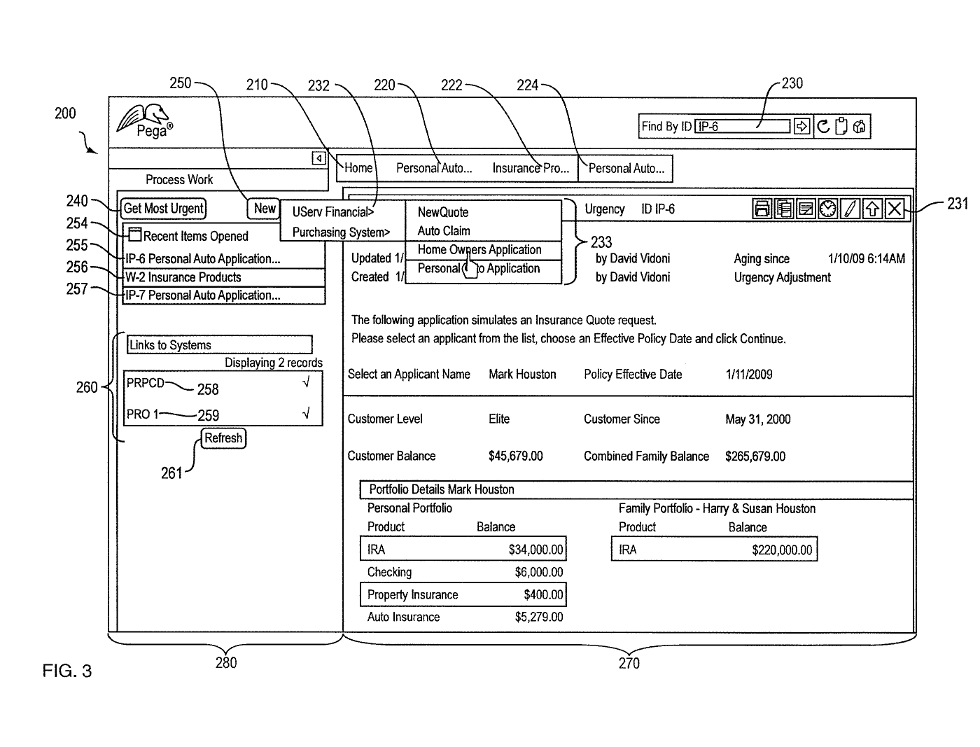

Systems and methods according to techniques described herein facilitate managing work centrally as well as in individual source systems within a distributed multi-system environment. This is depicted, by way of non-limiting example, in FIG. 1, in which operator 80 is connecting to the IWM system 60 through a client digital data processor 70 to any of review and process his/her combined work queue 72. The combined work queue 72 may be displayed in a user interface within a browser executing on the client digital data processor 70. As discussed below, the user interface may be displayed by the client in response to HTML or other codes transmitted to it by any of server 50 and source systems 10, 20 and 30 in request for a web page for an integrated work manager portal (see FIG. 3). The HTML or other codes may be generated by server 50 and/or source systems upon processing of rules (e.g., 45) in response to requests by the browser executing on the client 70 for the integrated work manager portal web page.

In the illustrated example, the combined work queue 72 comprises assignment data 46 related to individual work queues 12, 22 and 32 from source systems 10, 20 and 30, respectively. Just like the assignments contained in these individual work queues 12, 22 and 32, the combined work queue 72 may comprise pending assignments from both work lists and eligible workbaskets that the operator 80 can access on each source system. Among other things, this data is used to order the combined work queue 72 based upon prioritization rules 43 that may or may not specify the same prioritization criteria as individual source systems. To illustrate this point, the operator 80 in FIG. 1 is assumed to be a human resource representative (hereinafter “HR representative”) with access to individual work queues 12, 22 and 32 in all three source systems 10, 20 and 30, respectively. As mentioned above, each individual work queue for the operator is ordered according to urgency as specified by prioritization rules 3, 4 and 5 for all software applications executing on each source system. However, the prioritization rules 43 stored on the IWM system 60 may prioritize the assignments in the combined work queue 72 using the current context (e.g., security, privilege, roles etc. and other data associated with the operator) of the operator or other resource as the primary criteria and urgency value (as may be assigned for each source system) as a secondary criteria. Furthermore, the rules 43 of the IWM system 60 may prioritize items in a combined work queue in accordance with other information included in the assignment data such as the particular source system as well as type of work request (e.g., HR, legal, finance, etc.) in combination with the urgency level as assigned by an individual source system and the operator's current context. For example, the rules 43 may indicate that any pending work items and/or assignments generated by the ‘Legal’ source system 30 (i.e., by any software applications executing thereon) has a higher priority than those from other source systems. An embodiment in accordance with the techniques described herein may also utilize the techniques described in the '211 patent application noted above—that is, the prioritization rules 43 may specify criteria based upon, for example, skills and/or capabilities of a particular resource. Thus, the techniques described in the '211 patent application may be used by individual source systems (e.g., by specifying appropriate criteria using rules 3, 4, 5) and/or at an enterprise level across source systems in connection with the prioritization rules 43 for the combined work queue 72.

As shown in FIG. 1, the context-related data (e.g., operator role, skill level, locale, security and identification information etc.) may be transmitted to the IWM system 60 (e.g., via HTTP request) when the operator attempts to establish a connection with the IWM system 60 through a user interface executing on the client processor 70. This context -related data is used by the gateway to authenticate the resource before establishing a connection. In an embodiment, authentication may be performed when the gateway finds a match between the identification information of the resource attempting to make a connection and at least a portion of the context (e.g., security and identification information) of authorized resources (described below) from the one or more source systems interfaced with the IWM system 60 (here, 10, 20 and 30). Still other variations in authentication methods and techniques are possible in other embodiments of the invention.

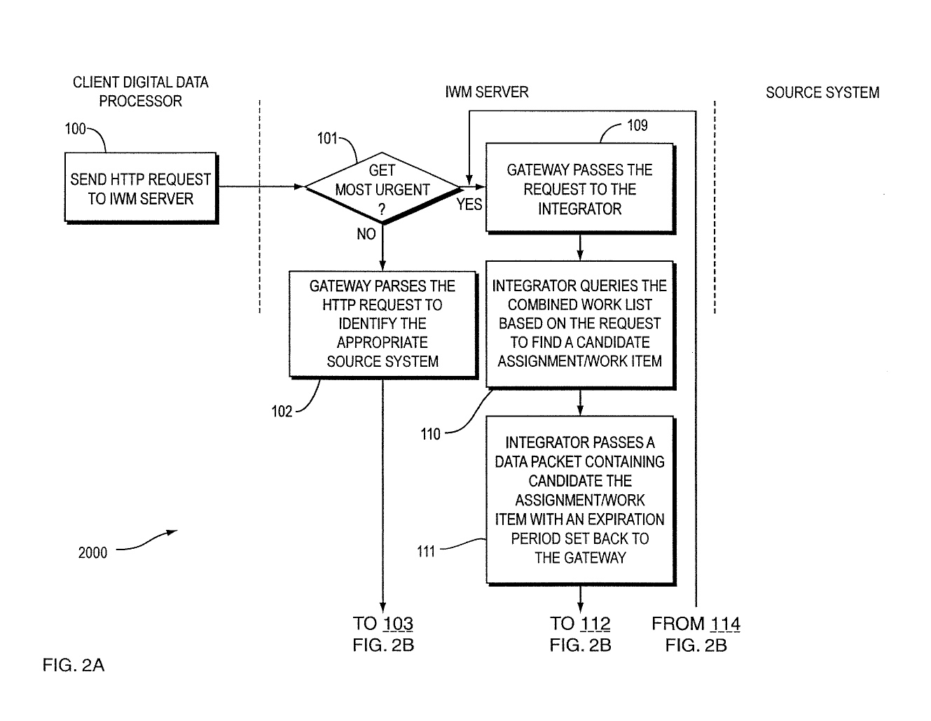

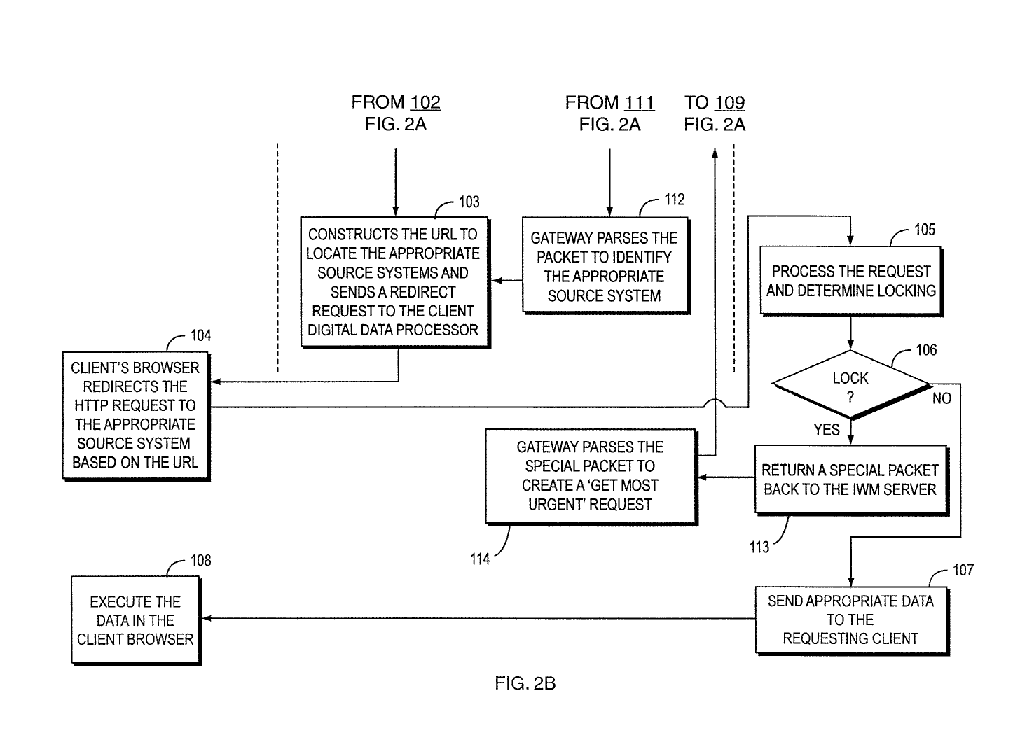

Once the resource is authenticated and a connection with the IWM system 60 is established, the gateway 61 on the IWM system 60 responds to the operator's request by passing the operator's context-related data to the integrator 63, which in turn, retrieves and executes the prioritization rules 43 in accordance with the current context. The manner of operation of the gateway 61 and the integrator 63, which may both be implemented in the same software module or in separate software modules, is discussed in further detail below and illustrated in FIGS. 2A and B.

Thus referring back to FIG. 1 and to the discussion above, the prioritization rules 43 use the assignment data 46 (e.g., urgency values) and context-related data (e.g., operator role) upon execution to evaluate the criteria specified by the rules and compile the combined work queue 72 accordingly. This is illustrated in FIG. 1, by the combined work queue 72 for operator 80 where, in light of the operator's current role of HR representative, both human resource (hereinafter “HR”) work items 11 and 6 and their associated assignments appear higher in the queue 72 than the Finance work item (e.g., Item 2) and associated assignments (e.g., having assignments 3 and 7) despite the fact that the Finance assignments have higher urgency values. However, for pending work where operator role or other context-related data is not a factor in ranking or ordering the work items and assignments in the combined work queue, all work items and associated assignments may be ordered by the corresponding urgency values in the combined work queue 72. In other words, if a prioritization rule indicates that only urgency is used to order work items and/or assignments in the combined work queue 72 rather than that context-related data in combination with urgency, then the work items and assignments may be ordered in accordance with only the associated urgency values. It will be appreciated that even though, in the illustrated embodiment, work queue ordering criteria is specified using rules that are executed on the IWM system 60 and/or source systems, in other embodiments the ordering criteria may be specified and/or applied otherwise. Furthermore, the ordering criteria can be based upon many factors and/or data elements other than urgency value, operator role and other context-related data, in other embodiments of the techniques herein.

In a typical embodiment as illustrated in FIG. 1, a client data processor 70 coupled to the IWM system 60 via a network 40 may be used by developers or end-user operators (e.g., operator 80) to define and/or update the prioritization rules 43 in order to customize the combined work queue (e.g., 72). By way of non-limiting example, operator 80 may wish to exclude from his/her combined work queue 72 work items and/or assignments that are part of a shared work pool (i.e., workbaskets) or those that are from the “Finance” source system 10. Furthermore, operator 80 may wish to re-order the combined work queue according only to urgency values. Operator 80 may change the prioritization rules 43 using the client processor 70 to specify the updated ordering criteria. In one embodiment when the operator 80 makes such a reordering request, the prioritization rules stored on the IWM 60 may not actually be modified or updated. Rather, the current view of the combined work queue 72 presented to the operator 80 may reflect a combined application of the prioritization rules 43 as stored on the system 60 with the reordering or ordering modification of the operator 80. In this example, the reordering request of the operator 80 may represent client-specific reordering criteria applied for the particular operator and/or operator session. Alternatively, when the operator 80 makes such a reordering request, the prioritization rules 43 may be updated so that the operator 80 actually modifies the rules 43 as stored in the IWM 60. Such updates may affect the work combined work queue 72 of operator 80 as well as possibly one or more other work queues of other resources. Whether an operator or other resource is allowed to update the prioritization rules 43 may vary with one or more different security measures that may be implemented in an embodiment. For example, different operations allowed by different resources may vary with context-related data provided such as the operator role where the IWM 60 may provide different roles with different allowed operations, accesses, and the like.

In FIG. 1, the illustrated repository 65 may consist of databases, data stores, and the like, stored on any conventional digital data storage medium (e.g., RAM, CD-ROM, read-only memory, hard disk etc.) for storing and retrieving assignment data 46, prioritization rules 43 and any other metadata (e.g., metadata for other rules 45) necessary to support the present architecture. The digitally encoded prioritization rules 43 and other rules 45 (e.g., user interface rules) that it contains are formatted and stored in the conventional manner known in the art. An example of the structure, operation and use of a repository, such as a rules base, and rules is provided in commonly assigned U.S. Pat. No. 5,826,250, entitled “Rules Bases and Methods of Access Thereof” and U.S. patent application Ser. No. 11/368,360, filed Mar. 3, 2006, entitled “Rules Base Systems and Methods with Circumstance Translation,” the teachings of both of which are incorporated herein by reference.

Moreover, the illustrated IWM system 60 is shown with a single server 50 that co-houses the repository 65, integrator 63 and the gateway 61, as discussed in more detail elsewhere herein. However, in other embodiments, multiple servers may be provided which may (or may not) include co-housed repository, integrator and the gateway. Still further, although server 50 of the illustrated embodiment is depicted as being remotely disposed from the client digital data processor 70, in other embodiments, one or more of the client devices may be disposed in vicinity of the server and, indeed, may be co-housed with it.

In the illustrated embodiment, the IWM system 60 may ‘pull’ the necessary data (e.g., assignment data 46) from source system(s) that it is interfaced with (here, 10, 20 and 30) or such source systems may ‘push’ the data to the IWM system. In connection with a data pull operation from the IWM system 60, the data request is initiated by the IWM system 60 and the source systems may reply or respond accordingly by providing the requested data. On the other hand, the data transmission is initiated by the source system(s) in a data ‘push’ model. Both methods of data transmission may be synchronous or asynchronous and can be implemented in a variety of ways using an automated background process (e.g., agent programs) that operates on each source system and/or the IWM system.

By way of non-limiting example, in a ‘push’ model, an agent program may be defined and stored on each source system that is interfaced with one or more IWM systems. This agent program may be configured to periodically (e.g., a specified interval, a recurring pattern of minutes, hours, days, upon an occurrence of a trigger event such as a source system generating a threshold number of new work items/assignments for processing, etc.) execute and transmit a pre-defined set of data from the source system to the one or more IWM systems. Furthermore, data pushed from the source systems to the one or more IWM systems may be a result of a programmed requests generated by such IWM systems. That is, a ‘client program’ running on the IWM systems may capture profiles (e.g. system information or user profiles) and then periodically initiate requests for data on behalf of the IWM systems and/or users. Similarly, in a pull model, an agent program may execute on the IWM system such that it periodically retrieves a predefined set of data from one or more source systems specified by the agent program. Still other methods and techniques of data transmission are possible in other embodiments of the techniques herein.

When designing agents executing or running on the source systems, it is important to consider the frequency with which the agent should perform processing and transmit data to the IWM system 60. Performing processing and transmitting such data from an agent too frequently may waste system and network resources whereas work processing can be severely hampered by an agent that does not transmit such data frequently enough. To illustrate this point, assume that a software application that handles mortgages is executing on the Finance source system 10. It may process fewer than 10 of these requests each day where each request generates a small number of assignments or tasks that may take days or even weeks to complete. Due to this low volume of requests and the infrequency with which the assignment data is updated, having the agent check for updates every five seconds would result in excessive processing. In contrast, having the agent every hour or even once a day might be sufficient. On the other hand, if the software application is processing 10,000 daily invoices with multiple assignments for each invoice getting completed the same day, having the agent run every five seconds may be necessary. Thus, considering the possibility of such variance in the optimal agent execution and/or data transmission time based upon the nature of the work being processed, the agent design in a pull model may be updated by developers every time a new source system is interfaced with the IWM system.

Moreover, the data transmitted to IWM system(s) from one or more source systems may vary in different embodiments of the techniques herein. In the illustrated example, source systems 10, 20 and 30 transmit assignment data 46 that is stored in the repository 65, as mentioned above. Furthermore, context-related data, such as, the operator profiles (including security and identification information, roles, privileges, skills etc.) for all authorized operators with direct access to the source systems, is transmitted to the IWM system 60 so that such operators can be authenticated when they attempt to connect to the source systems through the IWM system 60. In an embodiment where an authorized resource may be an application or system, the context-related data provided from the source system may include application or system profile information such as, for example, an application name or identifier, system name or identifier (e.g., an IP or other address or other network identifier), so that the IWM system 60 may properly authenticate authorized applications and/or systems. The particular type of context-related data used in connection with resources (as may be provided by one or more source systems) may vary with the particular resources in an embodiment. Furthermore, all workbasket records are transmitted to the IWM system 60 so that the same work pools are available to a resource on the IWM system as they are on each source system. Still further, source system names or other system information used to identify each particular source system, and or application(s) thereon, may be transmitted and stored in the repository 65 so that the IWM system can locate and/or identify the corresponding source system for each work item and/or assignment being created, reviewed and/or processed through the IWM system 60. Still other types of data may be transmitted and stored in the IWM system in other embodiments.

It will be appreciated that even though the illustrated resource for processing work in FIG. 1 is an operator 80, in other embodiments, a resource may comprise another digital data processor (with or without additional code executing thereon) and/or any other machine capable of processing (e.g., through an inbound service or batch processing) work items, assignments and/or tasks. For example, considering the finance invoice software application discussed above, a user may generate a work item in the source system 10 to create and process each international invoice. At a certain point in the invoice work item processing, an assignment associated with the invoice work item may be generated and put into the Pending-Research workbasket that is accessible by operator 80 as well as an external digital data processor to look up that day's exchange rate for the invoiced items. After the assignment data from source system 10 is transmitted to the IWM system 60, the same assignment may appear in the combined work queue 72 for the operator 80. Rather than operator 80 completing that assignment, an external digital data processor may send an inbound request (e.g., via SOAP or any other convention protocol) to take all such assignments out of the workbasket, access an external database to get the appropriate exchange rate, and return completed requests for the exchange information to requesting users. Once the information has been retrieved and the assignment is completed, the inbound request may also update the assignment data (e.g., set the assignment status to ‘Resolved’) on the source system in order to remove the completed assignment from work queues (e.g., by excluding assignment data transmission between source system(s) and the IWM system for assignments with a status of “Resolved”).

As part of initialization of the system of FIG. 1, each source system and/or application transmitting information (such as including assignment data) to the IWM system 60, may be established as a supplier of such information. For example, in a push data transmission model described above, processing may be performed on the IWM system 60 to define each source system and/or application as a ‘publisher’ prior to the IWM system 60 accepting such published information. In one embodiment, the source system and/or application may be required to transmit proper credentials and authentication information to the IWM system 60 prior to the system 60 accepting any published data. The use of such credentials and authentication information may be required in connection with each time period that data is published from a source system to the IWM system 60. It will be appreciated that an embodiment may use any of a variety of different techniques known in the art to ensure the identity of a source system as a data publisher as well as the integrity of the data published from the source systems to the IWM system 60.

Referring to FIGS. 2A and B, shown is a flowchart of processing steps that may be performed in an embodiment in accordance with the techniques herein such as the embodiment of FIG. 1. FIGS. 2A and B sets forth processing steps describing in further detail interactions between the digital data processors of FIG. 1. In step 100, a resource (such as, for example, an operator 80) initiates a request (e.g., by way of HTTP requests), via a client digital data processor (e.g., 70) to review, process and/or create work in a source system (e.g., 10, 20 or 30). The request can be initiated through a variety of different user interfaces (e.g., screen shown in FIG. 3) known in the art that may execute on a client digital data processor. Furthermore, methods of initiating the request may vary depending upon the type of request being generated. By way of non-limiting example, a user may review work by generating a query for a particular work item ID (i.e., an identifier uniquely identifying a work item within a particular source system) or by clicking on a work item/assignment from a list. Furthermore, an operator may retrieve the next highest priority item across multiple source systems from the operator's combined work queue (e.g., such as element 72 of FIG. 1) for processing by clicking a “Get Most Urgent” button on a screen (see FIG. 3). Still further, an operator may create a new work item by selecting a particular action from a list of types of work he/she can process (e.g., Auto Claim, Contract Request etc.) in a plurality of source systems (e.g., 10, 20 or 30). Still other variations in methods of request generation are possible in different embodiments of the techniques herein.

As illustrated by steps 103 and 104, generally in operation, the IWM system 60 responds to signaling, e.g., received from the client devices (e.g., by way of HTTP requests), by generating redirect requests for transmittal to the client devices (e.g., 70) in order to locate the appropriate source system to any of create, review or process work. However, the processing steps may vary depending upon the type of incoming requests.

Thus, for example, in step 101 the gateway determines the type of request and operation to be performed on the request and behaves differently depending upon whether the incoming request is a “Get most urgent” query or not. If step 101 evaluates to no indicating that the request is for any of creating, reviewing or processing an work item/assignment specifically identified in the request (e.g. an operator performing a search by work item ID or selecting a specific assignment to process), the gateway 61 parses the incoming request (e.g., HTTP data) to identify the appropriate source system as illustrated in step 102. In one embodiment, the gateway may identify the source system by comparing the prefix value (e.g. CR) of the work item ID specified in the request (e.g., CR-123) against the assignment data 46 from various source systems stored in the repository 65. The repository 65 may store prefix values associated with different types of work items/assignments that can be generated from each of one or more source systems and the corresponding source system identifier(s) (e.g., a URL, an IP address etc.). If a prefix value associated with a particular source system as stored in the repository 65 successfully matches the prefix value specified in the request, the gateway uses the corresponding source system identifier to construct the appropriate URL and sends a redirect message back to the client digital data processor as shown in step 103.

It will be appreciated that even though in the illustrated embodiment, the gateway uses the prefix value to locate the appropriate source system, in other embodiments, other data and techniques may be used to identify the source system. For example, the repository 65 may store the source system identifier(s) as part of each work item or assignment record from a source system. The gateway may, in turn, use the work item/assignment ID to retrieve the appropriate record and extract the source system identifier(s). Still other variations in methods and techniques of source system identification are possible.

In step 104, a browser executing on the client digital data processor 70 processes the redirect message and uses the URL constructed by the gateway to send the request directly to the appropriate source system. Such redirection of the client's initial request may happen automatically (unbeknownst to a user making the request) where only one source system is identified by the gateway. However, in situations where multiple source systems are identified (e.g., when the same prefix value is associated with two different source systems), the resource may be presented with a screen that displays an error or allows the resource to select the appropriate source system such that the resource can direct its request to the specified source system. In such cases, instead of the gateway sending a redirect message with a URL to the client processor 70, it may transmit a markup language stream, e.g., in HTML or other conventional format or protocol, for the screen (e.g., web page).

In steps 105 and 106, again, the processing of the request may vary in different embodiments depending upon the nature of the request and the source system design. By way of non-limiting example, if the request is for reviewing and/or processing an existing work item/assignment, the source system determines if that particular piece of work is already “locked” by another resource—that is, whether the particular work item/assignment is already being reviewed and/or processed by another resource. The work data structures (e.g., work item, assignment and the like) may be defined in the source system such that there may multiple pending assignments or tasks that are associated with a single work item. In such cases, a resource may be allowed to review/process pending assignments or work items even though other pending assignments associated with the same work item are locked by another resource. Still further, a resource may be allowed to review a portion of the data associated with a work item even though one or more assignments associated with the work item are locked by another resource. Still other variations in techniques for locking mechanisms are possible in other embodiments.

In the illustrated embodiment, the source system does not lock or check for a lock on an existing assignment or work item if a resource is simply reviewing it. For all “review” requests, as well as requests from a resource to create a new work item and/or assignment (depending upon the data structure definition in the source system), the source system constructs a markup language stream, e.g., in HTML or other conventional format or protocol, comprising the requested data. As shown in step 107, that stream (or, more accurately, markup language document) is transmitted by the source system, per convention, to the requesting client digital data processor (e.g., 70) for response by the resource. Even though, in the illustrated embodiment, the source system constructs and forwards the stream to the browser of the client device substantially concurrently with its request for the corresponding specified assignment or work item (i.e., during the same online session on which that request was made and/or within the conventional time periods expected for response to a web page), these are not requirements of an embodiment using the techniques herein. In step 108, the browser of the client device likewise substantially concurrently executes that stream for display to the resource, e.g., within that same online session and/or within the conventional time periods expected for execution of a web page although, again, this is not a requirement of the an embodiment utilizing the techniques herein. An exemplary resulting display is shown in FIG. 3, as described above.

It will be appreciated that the contents of the markup language stream may vary in different embodiments of the techniques herein depending upon the nature of the request. For example, in the illustrated embodiment, where the resource is creating a new work item and/or assignment, the stream comprises markup language for a user interface that allows the resource to respond to the source system by entering the relevant information needed to create the work item/assignment and transmitting the information to the source system, per convention, for processing and/or storage. For review requests, on the other hand, the stream may comprise the requested work/assignment data along with the markup language for a user interface that displays the data (hereinafter “review screen”). However, unlike the user interface for creating new work, the review screen may or may not provide a mechanism (e.g., a submit button or “process work” button) for the resource to submit a response to the source system upon completion of its review.

Referring back to steps 105/106 and to the discussion above, for requests by a resource to process work (e.g., an operator submitting a ‘Get most urgent’ query), a source system in the illustrated embodiment checks for a lock on that particular piece of work (e.g., work item and/or assignment). If the work item is not locked on the source system so that step 106 evaluates to no, the interaction between the client and source system proceeds as indicated in steps 107 and 108. However, if the particular work item and/or assignment is locked (e.g., due to another resource already processing the work item/assignment) so that step 106 evaluates to yes, the source system may return a special data packet back to the IWM server 60 as depicted in step 113. In turn, the gateway 61 parses the contents of the data packet to create another ‘Get Most Urgent’ query and passes it on the integrator as shown in steps 114 and 109. In step 110, the integrator 63 queries the assignment data 46 stored in the repository 65 in order to retrieve the next highest priority work item/assignment that can be processed by the requesting resource. The integrator may select the appropriate work item/assignment based upon the work item/assignment priority and current context of the requesting resource. For example, where the requesting resource is an operator, an operator identification or profile record as may be stored on the IWM system 60 may specify the workbaskets a particular operator can access and other selection criteria (e.g., selecting work from personal work lists before selecting work from a workbasket). Still other variations in selection criteria are possible in other embodiments.

Once the work item/assignment is identified and retrieved, the integrator passes the data back to the gateway in step 111. Also, in the illustrated embodiment, the integrator removes the work item/assignment from the combined work queue of the resource (e.g., 72) and sets an expiration period for such assignment/ work item. These measures improve work efficiency by preventing multiple ‘eligible’ resources (i.e., those resources with authorized access to process the same work) from trying to process the same work item/assignment simultaneously. In the event that the work item/assignment is not processed within the expiration period, the integrator may remove the expiration period setting and make the work item/assignment available again for processing by eligible resources. Furthermore, in the illustrated embodiment, the expiration period may be configurable by one or more designated users (e.g., system administrators, developers, end user operators) of the IWM system 60. This is useful because the IWM system may be deployed in a variety of different integrated work environments with different work processing requirements. Still further, even though in the illustrated embodiment, the expiration period is defined by a rule and stored in the repository 65, in other embodiments, the expiration period may be defined and stored differently. In the event that the work item/assignment is processed within the expiration period, the corresponding source system where the work item/assignment is processed, may propagate updated assignment data for the work item/assignment (e.g., with an assignment status of “Resolved” or “Completed”) to the IWM system 60 such that the IWM system 60 removes the work item/assignment from the list of outstanding assignments/work items (e.g., prioritization rules 43 exclude assignments with a “Resolved” status from the combined work queues). In other embodiment, resolved work items/assignments may be excluded all together when assignment data is transmitted to and/or retrieved by the IWM system 60, thus, removing such work items/assignments from the combined work queue. Still other variations in methods and techniques for removing completed work items/assignments from the combined work queue are possible in other embodiments.

It should be noted that the specified assignment may be processed when a resource, such as an operator, is directly connected to the appropriate source system or connected through the IWM system 60. Either way, the processing performed to complete the outstanding work item/assignment in a source system is in accordance with pre-configured processing steps defined, executed and/or stored in the corresponding source system.

In step 112, the gateway may use techniques similar to those described in connection with step 102 above (e.g., parsing the work item/assignment data to extract the source system identifier(s)) to identify the corresponding source system upon receiving the data packet from the integrator. Finally, the gateway redirects the request to the corresponding source system in order for the resource to continue processing the candidate work item/assignment as previously described in steps 103-108.

The techniques described above in steps 105-114 allow the gateway to handle ‘failures’ or latency issues. Consider the example of an enterprise where User 1 and User 2 both work in the Finance department. They both connect to an IWM system 60 through their respective client digital data processors to view their respective combined work queues where expense report 1 (ER1) is the highest priority work item/assignment for both users. Both User 1 and User 2 may simultaneously be viewing ER 1 on their respective combined work queues when User 1 clicks on ER1 fractions of a second before User 2 so that User 1 can perform the required work for ER1. Behind the scenes and unbeknownst to the users, the IWM system 60 allows User 1 to view and process the work item/assignment for ER 1 while marking the same work item/assignment as unavailable for User 2 such that when User 2 subsequently performs the same action (i.e., click on ER1) fractions of a second later than User 1, User 2 may be presented with the next most important item on User 2's combined work queue (e.g., ER2 for a work item/assignment for expense report 2 or POl for a work item/assignment for purchase order 1).

Referring now to FIG. 3, an exemplary screen 200 of a user interface executing on client digital data processor 70 is shown displaying an integrated work manager portal. The screen 200 further demonstrates a functional implementation of the above mentioned features of an embodiment of the techniques described herein.

In this embodiment of the user interface 200, the main panel on the right 270 allows an operator 80 to view the combined work queue (e.g., element 72 of FIG. 1), as well as navigate any source systems (e.g., 10, 20 and 30 of FIG. 1) with which the IWM system 60 interfaces. The operator can also directly access such source systems by selecting or highlighting a row (e.g., 258, 259) for the appropriate source system displayed in the “Links to Systems” section 260 of the left panel 280. Selection is accomplished by single-clicking on the desired row. Furthermore, the source system display list can be updated by the operator 80 by clicking the ‘Refresh’ button 261 as source systems periodically connect and/or disconnect from the IWM system 60. Still further, although not shown in the exemplary screen 200, there may be a ‘Disconnect’ button in other embodiments, displayed in the “Links to Systems” section 260 that allow users to disconnect the interface between the IWM system 60 and the one or more source systems listed in that section. It will be appreciated that the source system names “PRPC D” and “PRO 1” are exemplary and do not limit the type of source systems that may be interfaced with the IWM system or in any way limit methods/techniques of identifying source systems in an embodiment of the techniques described herein.

The content display in the main panel 270 can be controlled by tabs (e.g., 210, 220, 222 etc.) that appear on top of the main panel 270. When an operator logs on to the IWM system 60, the integrated work manager portal screen 200 displays the operator's combined work queue (e.g., 72) in the main panel 270 with the ‘Home’ tab 210 highlighted. From that view of the IWM system 60, an operator can perform a variety of actions including any of review, create and process work items (e.g., 255-257) and/or assignments across multiple source systems. Furthermore, during the performance of any such actions, an operator can return to viewing their combined work queue in the main panel 270 by clicking on the ‘Home’ tab 210.

By way of example, a resource may review a work item and/or assignment by selecting (e.g., by single clicking or otherwise) an item from its combined work queue 72 that is displayed under the ‘Home’ tab 210. A work item and/or assignment may also be reviewed by submitting a query based upon the work item ID and/or assignment ID. In the illustrated embodiment, a resource (e.g., an operator) can submit such a query through the ‘Find By ID’ input field 230 at the top of the screen 200 by entering a work item ID in 230 and single-clicking the arrow to the pointing to the right (located to the right of the field 230). It will be appreciated that the ID field is illustrative only and queries may be constructed using any unique work item/assignment identifier in other embodiments.

After a request to review a particular work item and/or assignment is submitted, the gateway 61 redirects the request to the appropriate source system using techniques described above (see FIGS. 2A and B and accompanying discussion) and displays the requested data in the main panel 270. By way of non-limiting example, in the illustrated embodiment, a personal auto insurance application work item IP-6 is displayed in the main panel 270 after a successful search using the work item ID (i.e., IP-6) is submitted through the ‘Find By ID’ input field 230. As the work item data is displayed in the main panel 270, a corresponding tab 224 appears and is highlighted on the top of the main panel showing the type of unit of work (e.g., Personal Auto Application) the requested work item represents on the source system. Similarly, in addition to review requests, tabs indicating corresponding work types appear on top of the main panel 270 for any work item and/or assignment that is either created or processed through the integrated work manager portal. This allows a resource to easily navigate between source systems, software applications, work items and/or assignments by simply clicking through the tabs (e.g., 210, 220, 222 and 224) and to review, create and/or process multiple work items/assignments simultaneously (e.g., each tab 210, 220, 222, 224 may be associated with one or more work items/assignments of a particular work type for which an operation is being performed). In order to improve work efficiency, avoid cluttering the user interface and hampering system performance, the screen 200 can be designed such that only a limited number of tabs can be open simultaneously. Once that limit is reached, the user interface can automatically close the oldest tab that was opened.

Resources using the screen 200 can also close individual work items by clicking the ‘x’ button 231 on the work item display. If that is the only work item open for a particular work type, the corresponding tab identifying the work type may be automatically closed. However, if there are multiple work items open of the same work type, all of such work items need to be closed for the corresponding tab for that work type to disappear. Alternatively, a resource can close all open work items for a particular work type by clicking the ‘x’ mark displayed on each tab when it is highlighted (e.g., 224).

For instance, the illustrated ‘Recent Items Opened’ folder 254 in the left panel 280 contains two open personal auto insurance work items, 255 and 257, along with an open insurance products work item 256. The resource using screen 200 can switch the display of the work items 255 and 257 in the main panel 270 under the same tab 224 by highlighting or selecting the row for the respective work items listed under the folder 254. Selection is accomplished by single-clicking on the desired row. Similarly, if the resource selects the row for the insurance products work item 256, the display in the main panel 270 switches to show the contents of the selected work item under a highlighted ‘Insurance Products’ tab 222. Since there is only one work item 256 open for the ‘Insurance Products’ work type, closing that work item may also close the corresponding tab 222. However, the resource has to individually close both personal auto work items 255 and 256 or click the ‘x’ on the highlighted ‘Personal Auto Application’ tab 224 to make that tab disappear.

In addition to methods of reviewing work mentioned above, a resource can review and/or process work by clicking the ‘Get Most Urgent’ button 240 on the screen 200. This generates a ‘Get most urgent’ query (as described previously in connection with FIGS. 2A and B) in order to retrieve the next highest priority work item and/or assignment to be processed, and to display the requested data in the main panel 270. Unlike the illustrated work item IP-6 that is simply being reviewed by a resource, the display in the main panel 270 may be different for a work item and/or assignment that is being processed, updated and/or acted upon for any purpose than reviewing (e.g., read only). For example, all the fields displayed in the main panel 270 may not be read-only (e.g., as shown for work item IP-6). This allows the resource to input and/or update data associated with the work item and/or assignment being processed. Furthermore, the markup language stream for screen 200 and/or the display in the main panel 270 (collectively hereinafter “web page”) may incorporate logic such that inputs and/or updates by the resource vis-a-vis the input fields are processed by the corresponding source system either upon a “submit action” by the resource vis-a-vis the web page or prior to and/or in the absence of such an action. Moreover, the logic may permit information generated by the corresponding source system (based on such processing) that is transmitted back to the client digital data processor 70 to be incorporated into the web page, again, prior to and/or in the absence of a submit action by the resource vis-a-vis the displayed web page. Indeed, while the data is being transmitted to and processed by the source system, and while the information generated by the source system is being transmitted back to the client digital data processor (e.g., 70 rendering the web page) and loaded into the display fields, the resource can continue reviewing the web page and entering/modifying data on the web page.

As used here, a “submit action” may be characterized as a resource action intended to signify that input fields of the web page are completed (or sufficiently completed) and ready for submission to a server digital data processor (e.g., source systems, IWM system 60). These are conventional actions known in the art, such as, user selection of the “submit button” (including, user selection of a designated radio button on the web page or user selection of a designated submit button on the web page), and/or user striking of the ENTER key (or the like) on the client digital data processor while a focus is on any of the web page or one of its input fields.

In an embodiment using the techniques herein, the logic incorporated on the web page that causes such “pre-” or “asynchronous” processing (i.e., processing that occurs prior to or in the absence of a submit action) of ‘data’ (e.g., point-and-click selections, gestures and so forth made with respect to at least various display/input/output fields of the web page) may be defined by rule(s) that are stored and/or executed on a server digital data processor (e.g., source system or IWM system). Furthermore, the same rule(s) or one or more different rules may be used to define the layout and/or configuration of the webpage. An example of a system and method that, among other things, can be used to process rules to generate a user interface and perform such pre-processing of data is disclosed in the commonly assigned U.S. patent application Ser. No. 11/396,415, filed Mar. 30, 2006, entitled “User Interface Methods and Apparatus for Rules Processing,” and U.S. patent application Ser. No. 12/035,682, filed Feb. 22, 2008, entitled “User Interface Methods and Apparatus for Rules Processing”, both of which are incorporated herein by reference.

In the illustrated embodiment, the work manager portal screen 200 is a combination of static and dynamic components. In other words, the overall configuration and placement of the various sections (e.g., left panel 280, right panel 270, top half displaying ‘Find By ID’ etc.) of the portal remains static while the contents of some or all of the sections may be rendered dynamically based upon rules being executed and/or processed on the IWM system 60 and the source system(s) at any given point in time.

By way of non-limiting example, the layout and/or configuration of the portal screen 200 may be defined by one or more rules 45 stored on the IWM system 60. In operation, when an operator logs on to the IWM system 60 through a client digital data processor 70, the browser of the client 70 may generate a request for the “integrated work manager portal” web page 200. The request passes through the gateway 61 to the integrator 63, which in turn, retrieves rules 45 implicated by that request from the repository 65 (if it has not already done so), as determined by the request itself, the context (e.g., security settings and privileges for the user), the state of currently executing rules for that user, and so forth. The integrator 63 then processes those rules, (e.g., in view of that context) to select which fields (e.g., Find By ID), submit buttons (here, ‘New’ or ‘Get Most Urgent’)), display elements, etc., to include on the web page 200 and how to configure those elements. Moreover, the integrator 63 also retrieves the assignment data 46 from the repository 65 and processes such data to order the combined work queue for that user by evaluating one or more criteria specified by the prioritization rules 43 in accord with the assignment data and/or the context. As a result of such data and rule processing, a markup language stream is transmitted to the client digital data processor in order to render the combined work queue in the main panel 270 under the ‘Home’ tab 210. Thereafter, the display of information in the main panel 270 under each tab corresponding to different work types (e.g., 220, 222 and 224) may be defined in a variety of different ways in different embodiments of the techniques herein.

In the illustrated embodiment, the gateway 61 redirects the resource's requests (e.g., HTTP requests) to create, review and/or process work from the IWM system 60 to an appropriate source system. In response to the request, the markup language stream transmitted to the IWM system 60 from the corresponding source system contains the work/assignment data to be displayed as well as the layout definition for the display of such data (e.g., in view of the current context) under the appropriate tab. In other embodiments utilizing the techniques herein, the markup language stream may only comprise the requested work/assignment data that is reconfigured for display under the appropriate tab based upon rule(s) defined and stored on the IWM system 60. Still other variations in methods and techniques for user interface definition, generation and data processing are possible in different embodiments.

As mentioned above, a resource may be able to create new work items and/or assignments in one or more source systems by connecting to such systems through the IWM system 60 using the integrated work manager portal screen 200. For example, based upon an operator's current context (e.g., security, privilege, roles etc. associated with the operator), he/she may be able to view the ‘New’ button 250 in the left panel of the screen 200. When the operator clicks that button, a list of eligible software application(s) (i.e., software application(s) executing on one or more source systems that the operator has access to) appears in a pop-up screen 232. Highlighting or selecting each application in the pop-up screen may further display a list 233 of eligible work item types (here, New Quote, Auto Claim, Home Owners Application and Personal Auto Application) that can be created by the operator with the selected software application. Operator selection of a work item type from the list 233 initiates a request (e.g., HTTP request) to create the specified new work item in the corresponding source system where the selected software application is being executed. Again, the gateway 61 parses the request to locate the corresponding source system (e.g., by construction the URL or otherwise) and redirects the operator's request to that system in order to initiate the creation and subsequent processing of the specified work item based upon processing steps defined by the software application.

In the illustrated embodiment, the display of information under each work item tab (e.g., 220, 222 and 224) in the main panel 270 during creation, review and processing of a work item/assignment is the same as if the operator were directly logged into the corresponding source system(s). Therefore, depending upon the context (e.g., resource's security settings, locale, system settings etc.) and/or user interface definitions of such source systems, the screen 200 may provide a consolidated view of enterprise content (e.g., business rules and data, policies, procedures, processes, workflows etc. stored in such source systems) across all eligible source systems regardless of their number, version, geographical location, system specifications, and the like.

In an embodiment in accordance with the techniques herein, an integrated view of work items and/or assignments as a combined work queue 72 is provided across multiple source systems for different types of work. A resource, such as an operator, may connect to the IWM system 60 and is automatically directed to the proper source system when processing, reviewing and/or creating work. If a source system is down or otherwise unavailable, the IWM system may simply provide a combined work queue for all remaining source systems such that the work items/assignments for the source system that is unavailable may be excluded from the combined work queue.

An embodiment in accordance with techniques herein may provide a resource, such as an operator, with an option of specifying (such as via user interface selections) the one or more source systems and/or applications that may supply the data for review, update and/or processing by the IWM system 60 using techniques and operations described herein. For example, an operator may specify that for the purposes of retrieving the highest priority work for that operator, a “Get Most Urgent” query exclude data related to work items/assignments from a particular source system. Such specifications by a resource may be used for a single current session as well as subsequent sessions for the same resource until modified. An embodiment may also provide for automatically updating the list of available source systems and automatically modifying the list of source systems excluded/included for use with IWM system 60 processing such as to produce the combined work list and/or workbasket.

In one embodiment using a push data model, a source system may periodically propagate security-related data so that if a new resource, such as a new operator, is allowed direct access to the source system, the IWM system 60 is accordingly informed. Furthermore, such security-related information may indicate what types of operations with respect to different work types a particular operator is allowed to perform in each different source system. Since such information about an operator may be periodically updated, such information may also be synchronously or asynchronously (e.g., depending upon the specifications for the agent program transmitting the data) propagated to the IWM system 60.

As also described above (e.g., in connection with FIGS. 2A and B), .the IWM system 60 may handle automatically failing over to an available source system for a work item/assignment to be processed as attempts to connect to unavailable source systems are unsuccessful. For example, if for any reason a selected work item/assignment is locked or otherwise not available, an embodiment may automatically retrieve the next high priority work item/assignment from the combined work queue. Thus, in the event that one or more source systems are down, offline, or otherwise unavailable for use by an operator and the operator is not aware of the current state of such source systems, the operator is automatically directed to an available source system to create, review and/or process a work item/assignment in the available system.

An embodiment in accordance with the techniques described herein allows resources to manage/process work across a plurality of source systems by either connecting to such source systems through the IWM system 60 or by connecting directly to each source system. For example, an operator may directly log in to a source system and execute a “Get Most Urgent” query. However, performing such an operation to retrieve the next highest priority work item and/or assignment when communicating directly with the source system will result in retrieving the highest priority work item and/or assignment with respect to that source system only (e.g., such as from a single list 12 of FIG. 1 when communicating with the Finance system 10). In contrast, as described above, executing a “Get Most Urgent” query when communicating with the IWM system 60 will result in retrieving the highest priority work with respect to all source systems interfaced with the IWM system 60 (e.g., 10, 20 and 30). Thus, an embodiment may provide the IWM system 60 and functionality in addition to the existing operations and functionality provided by legacy source systems.

It should be noted that even though a portion of information associated with work items (e.g., assignment data) may be transmitted to the IWM system 60 for use in producing the combined work queue, the work items and their associated data are generally stored, maintained and processed in each individual source system.

In connection with an embodiment of the IWM system 60 as described herein, the prioritization rules, or more generally the prioritization criteria, used to order a combined work queue for a resource may perform prioritization across multiple source systems based on time/age of an outstanding work item/assignment in determining a priority of the outstanding item on a combined work list, and/or a workbasket, and the like.

It should be noted that as described herein, a single IWM system 60 is shown interfaced with multiple source systems. An embodiment may also include multiple IWM systems where one or more source systems each communicate with the multiple IWM systems using the techniques described herein. For example, a large bank may wish to have one IWM system for retail banking related work and a separate IWM system that consolidates work across the wholesale banking division in the bank. In this type of an enterprise architecture, a single financial source system may communicate with both IWM systems if that source system creates and/or processes work related to both retail and wholesale banking

As described above, the techniques herein have application, by way of non-limiting example, to enable organizations to provide centralized navigation and processing capabilities for its enterprise content/work while facilitating execution on distributed platforms and technology versions. The techniques herein provide for improved methods and apparatus for digital data processing and present an enterprise view of work across all enterprise applications regardless of their number, version, geographical location, and the like. The techniques described herein provide for methods and apparatus that facilitate creating, prioritizing, viewing, retrieving and processing work across multiple systems as if they were unified. A centralized directory of enterprise content across multiple applications may be provided. The techniques herein may be used with legacy, as well as new, applications, and may be implemented and operated at reduced expense on existing and new platforms. The techniques as described herein provide such methods and apparatus that allow organizations to manage work centrally as well as in individual systems in a distributed multi-system environment.

An embodiment in accordance with techniques described herein may include functionality to perform one or more of: generate a combined work queue for one or more resources across multiple source systems, provide one or more workbaskets of assignments/work items that can be performed by more than one resource, retrieve a highest priority work item/assignment for a resource from the resource's combined work queue, create a new work item, retrieve a specified work item/assignment in accordance with an identifier such as an assignment ID and/or work item ID, and other processing operations as described above.

The techniques herein may be performed by executing code which is stored on any one or more different forms of computer-readable media. Computer-readable media may include different forms of volatile (e.g., RAM) and non-volatile (e.g., ROM, flash memory, magnetic or optical disks, or tape) storage which may be removable or non-removable.

While the invention has been disclosed in connection with preferred embodiments shown and described in detail, their modifications and improvements thereon will become readily apparent to those skilled in the art. Accordingly, the spirit and scope of the present invention should be limited only by the following claims.

1.-52. (canceled)

53. An integrated work management system comprising:
a plurality of source systems including digital data processors that each process an individual work queue generated by each source system in the plurality of source systems, wherein each individual work queue includes at least one work item representing at least one assignment to be completed by at least one resource; and
a server digital data processor communicatively coupled with the one or more source systems, wherein the server digital data processor is configured to:
generate a combined work queue by aggregating work items for the at least one resource from each individual work queue generated by each source system in the plurality of source systems;
receive a request for a specified work item in the combined work queue from a client digital data processor;
parse the received request to identify a source system from among the plurality of source systems that processes the specified work item;
construct a resource locator for the identified source system; and
transmit a redirect request to the client digital data processor, the redirect request using the resource locator to cause the identified source system to transmit a markup language stream to the client digital data processor for display in a portal user interface executing on the client digital data processor, wherein the portal user interface renders the markup language stream to display information associated with the specified work item within a composite view of information associated with at least a portion of the plurality of source systems and the combined work queue.

54. The system of claim 53, wherein each source system in the plurality of source systems is any of a single server and a cluster.

55. The system of claim 53, wherein each source system in the plurality of source systems is configured to support one or more software applications.

56. The system of claim 53, wherein the server digital data processor is further configured to set an expiration period for the specified work item and remove the specified work item from the combined work queue for the duration of the expiration period.

57. The system of claim 53,
wherein the server digital data processor is configured to generate the combined work queue by ordering the aggregated work items for the at least one resource from each individual work queue according to combined prioritization criteria that include primary criteria and secondary criteria.

58. The system of claim 57, wherein the server digital data processor is configured to generate the combined work queue upon a determination that the at least one resource is authenticated.

59. The system of claim 57, wherein the primary criteria include a current context of the at least one resource and the secondary criteria include urgency.

60. The system of claim 59, wherein the current context includes any of security and identification data, roles, privileges, skills, age, locale, and disability settings of the resource.

61. The system of claim 53, wherein the specified work item includes a next item with highest priority in the combined work queue.

62. The system of claim 61, wherein the specified work item includes a subsequent item with highest priority in the combined work queue, upon a determination that the next item with highest priority in the combined work queue is locked by another resource.

63. A method for integrated work management, the method comprising:
generating a combined work queue by aggregating work items for at least one resource from each individual work queue generated by each source system in a plurality of source systems, wherein each individual work queue includes at least one work item representing at least one assignment to be completed by at least one resource;
receiving a request for a specified work item in the combined work queue from a client digital data processor;
parsing the received request to identify a source system from among the plurality of source systems that processes the specified work item;
constructing a resource locator for the identified source system; and
transmitting a redirect request to the client digital data processor, the redirect request using the resource locator to cause the identified source system to transmit a markup language stream to the client digital data processor for display in a portal user interface executing on the client digital data processor, wherein the portal user interface renders the markup language stream to display information associated with the specified work item within a composite view of information associated with at least a portion of the plurality of source systems and the combined work queue.

64. The method of claim 63, wherein each source system in the plurality of source systems is any of a single server and a cluster.

65. The method of claim 63, wherein each source system in the plurality of source systems is configured to support one or more software applications.

66. The method of claim 63, further comprising:
setting an expiration period for the specified work item; and
removing the specified work item from the combined work queue for the duration of the expiration period.

67. The method of claim 63, wherein the generating the combined work queue includes ordering the aggregated work items for the at least one resource from each individual work queue according to combined prioritization criteria that include primary criteria and secondary criteria.

68. The method of claim 67, wherein the generating the combined work queue is performed upon a determination that the at least one resource is authenticated.

69. The method of claim 67, wherein the primary criteria include a current context of the at least one resource and the secondary criteria include urgency.

70. The method of claim 69, wherein the current context includes any of security and identification data, roles, privileges, skills, age, locale, and disability settings of the resource.

71. The method of claim 63, wherein the specified work item includes a next item with highest priority in the combined work queue.

72. The method of claim 71, wherein the specified work item includes a subsequent item with highest priority in the combined work queue, upon a determination that the next item with highest priority in the combined work queue is locked by another resource.
